(19) United States
(12) Patent Application Publication
(10) Pub. No.: US 2009/0327573 A1
(43) Pub. Date: Dec. 31, 2009

(54) SEMICONDUCTOR MEMORY DEVICE

(75) Inventor: Ji-Eun JANG, Gyeonggi-do (KR)

Correspondence Address: IP & T Law Firm PLC, 7700 Little River Turnpike, Suite 207, Fairfax, VA, 22003, US

(73) Assignee: HYNIX SEMICONDUCTOR, INC., Gyeonggi-do (JP)

(21) Appl. No.: 12/265,951

(22) Filed: Nov. 6, 2008

(30) Foreign Application Priority Data
Jun. 30, 2008 (KR) 10-2008-0063180

(51) Int. Cl. G06F 12/06

(52) U.S. Cl. 711/5; 711/E12.082

(57) ABSTRACT

A semiconductor memory device, including a memory banks and associated local data buses, and a bus connection circuit connected to the local data buses associated with two or more of the memory banks to perform a selective data transfer between a global data bus and those local data buses.

### CROSS-REFERENCE TO RELATED APPLICATION

The present invention claims priority from Korean patent application number 10-2008-0063180, filed on Jun. 30, 2008, which is incorporated by reference in its entirety.

### BACKGROUND OF THE INVENTION

The present invention relates to a semiconductor memory device, and more particularly, to a semiconductor memory device where an amplifier and a write driver are shared by two or more banks to reduce the size of the semiconductor memory device.

A semiconductor memory device stores data input from the outside and outputs stored data. The semiconductor memory device includes a bus serving as an input/output path for data. Such a bus includes a data input/output pad (DQ pad), a global bus (GIO) for transferring data between banks, and a local data bus pair (LIO and LIOB) provided to each bank.

FIG. 1 is a block diagram illustrating a data input/output path of a typical semiconductor memory device. During a write operation, a data input to a data pin DQ is loaded on a global bus GIO through a data input/output driver 130. Then, the data is transferred through the global bus GIO to a bank 0 110 or a bank 1 120. Specifically, when the bank 0 110 is selected according to a bank address, the data on the global bus GIO is loaded on a local data bus pair LIO_B0/LIOB_B0 by a write driver (WTDRV) 112. The data on the local data bus pair LIO_B0/LIOB_B0 is stored in a memory cell inside the bank 0 110. When the bank 1 120 is selected according to the bank address, the data on the global bus GIO is loaded on a local data bus pair LIO_B1/LIOB_B1 of the bank 1 120 by a write driver 112, and then stored in a memory cell inside the bank 1 120.

During a read operation, when the bank 0 110 is selected according to a bank address, a data stored in the bank 0 is loaded on the local data bus pair LIO_B0/LIOB_B0. The data transferred through the local data bus pair LIO_B0/LIOB_B0 is amplified in the input/output sense amplifier (IOSA) 111 and then loaded on the global bus GIO. The data transferred through the global bus GIO is output through the data pin DQ to an outside by the data input/output driver 130. When the bank 1 120 is selected according to the bank address, a data stored in the bank 1 120 is loaded on the local data bus pair LIO_B1/LIOB_B1. The data transferred through the local data bus pair LIO_B1/LIOB_B1 is amplified in the input/output sense amplifier 121 and then loaded on the global bus GIO. The data transferred through the global bus GIO is output from the memory device through the data pin DQ by the data input/output driver 130.

Each bank is provided with as many local data bus pairs (LIO/LIOB) as the global buses (GIO). Each local data bus pair (LIO/LIOB) is provided with a write driver (WTDRV) and an input/output sense amplifier (IOSA). For example, a semiconductor memory device performing an 8-bit prefetch and ×16 operation includes 128 global buses (GIO). Thus, each bank of the semiconductor memory device is provided with 128 local data bus pairs (LIO/LIOB), 128 write drivers (WTDRV), and 128 input/output sense amplifiers (IOSA). Accordingly, the semiconductor memory device including 8 banks have 1024 write drivers (WTDRV) and 1024 input/output sense amplifiers (IOSA) in total.

Such a great number of write drivers (WTDRV) and input/output sense amplifiers (IOSA) are one of the major causes for increasing the size of the semiconductor memory device and thus increasing its production cost.

FIG. 2 is a block diagram illustrating a data output path for a parallel test of a semiconductor memory device.

In a normal mode, only one bank is operated at a time. However, in a parallel test mode, all the banks are operated at the same time. In FIG. 2, only two banks are shown as an example.

Data read from the bank 210 are transferred through local data bus pairs LIO_B0/LIOB_B0 to respective input/output sense amplifiers 211. The input/output sense amplifiers 211 output the data to test buses TGIO_BK0 in one to one correspondence with the local data bus pairs LIO_B0/LIOB_B0. A test result signal generator 212 receives the plurality of data through the test buses TGIO_BK0 to output a single test result signal. Similarly, a plurality of data read from the bank 220 are transferred through a plurality of local data bus pairs LIO_B1/LIOB_B1 to input/output sense amplifiers 221, respectively. The input/output sense amplifiers 221 output the plurality of data to test buses TGIO_BK1 in one to one correspondence with the local data bus pairs LIO_B1/LIOB_B1. A test result signal generator 222 receives the plurality of data through the test buses TGIO_BK1 to output a single test result signal.

As described above, the test result signal generators 212 and 222 each performs compression of the plurality of data by converting the data to the single test result signal. Specifically, the test result signal generators 212 and 222 each determines whether the received data have all the same value and then outputs the result as the test result signal. In the parallel test mode, all the cells store the same data, and thus, if there is any data having a value different from the others, the data can be determined as having errors (as failing). If all the data have the same value, the data can be determined as having no errors (as passing). As a result, the test result signal generators 212 and 222 each output a single data bit indicating whether the plurality of data have all the same value.

The test result signals output from the test result signal generators 212 and 222 are transferred through test global buses GIO_TM_BK0 and GIO_TM_BK1 to data input/output drivers 213 and 223, respectively. Then, the test result signals indicating either pass or fail are output from the semiconductor memory device to the outside.

FIG. 3 is a circuit diagram of an input/output sense amplifier in a typical semiconductor memory device.

The configuration of the input/output sense amplifier is well known to those skilled in the art. Accordingly, only an overall operation of the input/output sense amplifier will be described briefly herebelow.

Data input to the input/output sense amplifier are transferred through the local data bus pair LIO/LIOB and amplified. Then, the amplified data are transferred to the nodes DATA and DATAB.

When a parallel test signal TPARA is deactivated, i.e., in a normal mode, data of the nodes DATA and DATAB are transferred to a global bus GIO.

When the parallel test signal TPARA is activated, i.e., in a parallel test mode, the data of the nodes DATA and DATAB are transferred to a test bus TGIO.

That is, the input/output sense amplifier amplifies the data on the local data bus to transfer the amplified data to the global bus in the normal mode, and amplifies the data on the local data bus to transfer the amplified data to the test bus in the parallel test mode.

FIG. 4 is a timing diagram illustrating a read operation of a typical semiconductor memory device in a normal mode.

When a first read command RD is input together with a bank address for selecting a bank 0, a column command signal CASP<0> of the bank 0 is activated. Then, the bank 0 performs a read operation. Surely, a strobe signal IOSTB_B0 for strobing an input/output sense amplifier of the bank 0 is also activated during the activation period of the column command signal CASP<0> to enable the input/output sense amplifier (IOSA) of the bank 0.

When a second read command RD is input together with a bank address for selecting a bank 1, a column command signal CASP<1> of the bank 1 is activated. Then, the bank 1 performs a read operation. Surely, a strobe signal IOSTB_B1 is also activated during the activation period of the column command signal CASP<1> to enable the input/output sense amplifier (IOSA) of the bank 1.

Operations performed in response to third and fourth read commands RD, which are input together with a bank address for selecting a bank 2 and a bank address for selecting a bank 3, respectively, are identical to the above described operations performed in response to the first and second read commands RD.

FIG. 5 is a timing diagram illustrating a read operation of a typical semiconductor memory device in a parallel test mode. When a read command RD is input, all column command signals CASP<0:3> of respective banks are activated at the same time. Then, all the banks perform read operations. Also, strobe signals IOSTB_B0 to IOSTB_B3 for the input/output sense amplifier (IOSA) are activated during the activation period of the column command signal CASP<0:3> to transfer the data on a local data bus pair (LIO/LIOB) to a test bus (TGIO).

As described above, the data transferred to the test bus (TGIO) are compressed by the test result signal generator and then output to the outside. To input/output data at a high speed, a large number of data are required to be accessed, and thus the numbers of local data buses (LIO and LIOB) and global buses (GIO) are being increased. Accordingly, the numbers of input/output sense amplifiers (IOSA) and write drivers (WTDRV) are increasing. As a result, the net die size of the semiconductor memory device is increasing.

The increase of the die size results in the increase of production cost of the semiconductor memory device and thus a decrease of the competitive power of the memory manufacturer. Therefore, there is a need for a technology for reducing the area required for the input/output sense amplifiers (IOSA) and the write drivers (WTDRV).

### SUMMARY OF THE INVENTION

Embodiments of the present invention are directed to providing a semiconductor memory device of a reduced size by reducing an area in the semiconductor memory device required for input/output sense amplifiers and write drivers.

In accordance with an aspect of the invention, a semiconductor memory device includes a plurality of memory banks provided with a plurality of local data buses, and a bus connection circuit connected to the local data buses that are provided to the two or more memory banks to perform a selective data transfer between a global data bus and the local data buses.

In accordance with another aspect of the invention, a semiconductor memory device includes a plurality of memory banks provided with a plurality of local data buses, a selector connected to the local data buses that are provided to the two or more memory banks to select data loaded on one of the local data buses, and a sense amplifier configured to transfer the data selected by the selector to a global data bus.

In accordance with still another aspect of the invention, a semiconductor memory device includes a plurality of memory banks having a plurality of local data buses, a write driver configured to transfer data loaded on a global data bus to the local data buses, and a selector connected to the local data buses that are provided to the two or more memory banks to select one of the local data buses on which the data transferred from the write driver is loaded.

In accordance with a further aspect of the invention, a semiconductor memory device includes a plurality of memory banks provided with a plurality of local data buses, and a bus connection circuit connected to the local data buses that are provided to the two or more memory banks to perform a selective data transfer between a global data bus and the local data buses, wherein the bus connection circuit is configured to perform a selective data transfer between the local data buses that are provided to the two or more memory banks and test buses corresponding to the two or more memory banks during a read operation of a parallel test mode.

In accordance with another aspect of the invention, a semiconductor memory device includes a plurality of memory banks provided with a plurality of local data buses, a first selector connected to the local data buses that are provided to the two or more memory banks to select data loaded on one of the local data buses according to a bank address in a normal mode, and sequentially select data loaded on the local data buses during a read operation of a parallel test mode, a sense amplifier configured to transfer the data received from the first selector to a global data bus in a normal mode, and transfer the data received from the first selector to a second selector in the parallel test mode, and the second selector configured to sequentially transfer the data received from the sense amplifier to two or more test buses.

### BRIEF DESCRIPTION OF THE DRAWINGS

FIG. 1 is a block diagram illustrating a data input/output path of a typical semiconductor memory device.

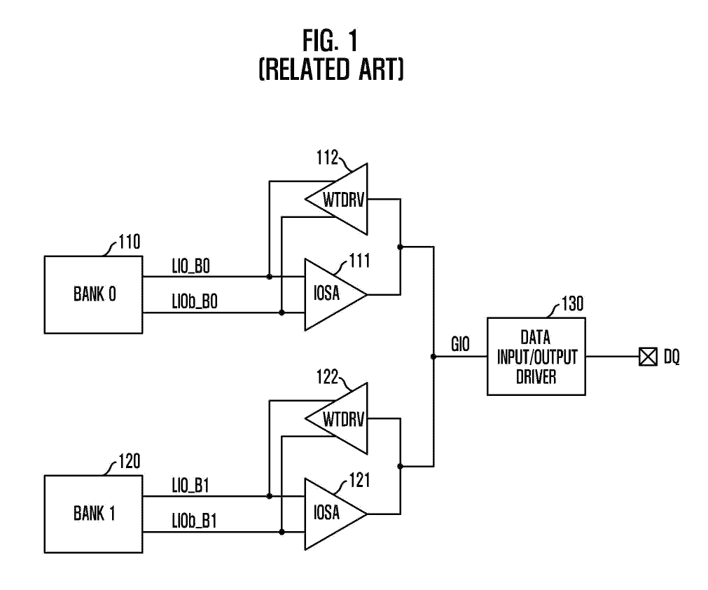

FIG. 2 is a block diagram illustrating a data output path for a parallel test of a semiconductor memory device.

FIG. 3 is a circuit diagram of an input/output sense amplifier in a typical semiconductor memory device.

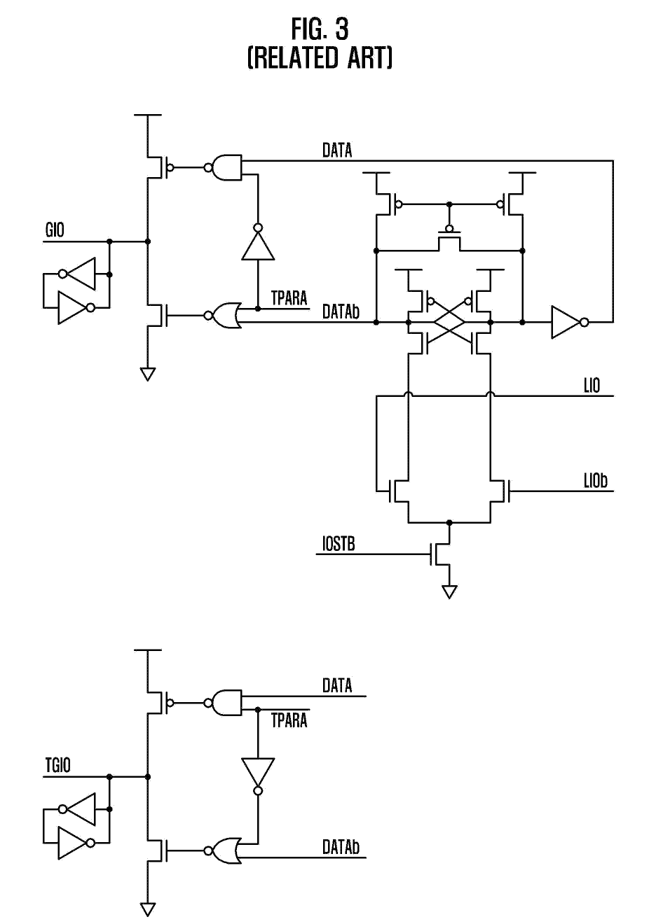

FIG. 4 is a timing diagram illustrating a read operation of a typical semiconductor memory device in a normal mode.

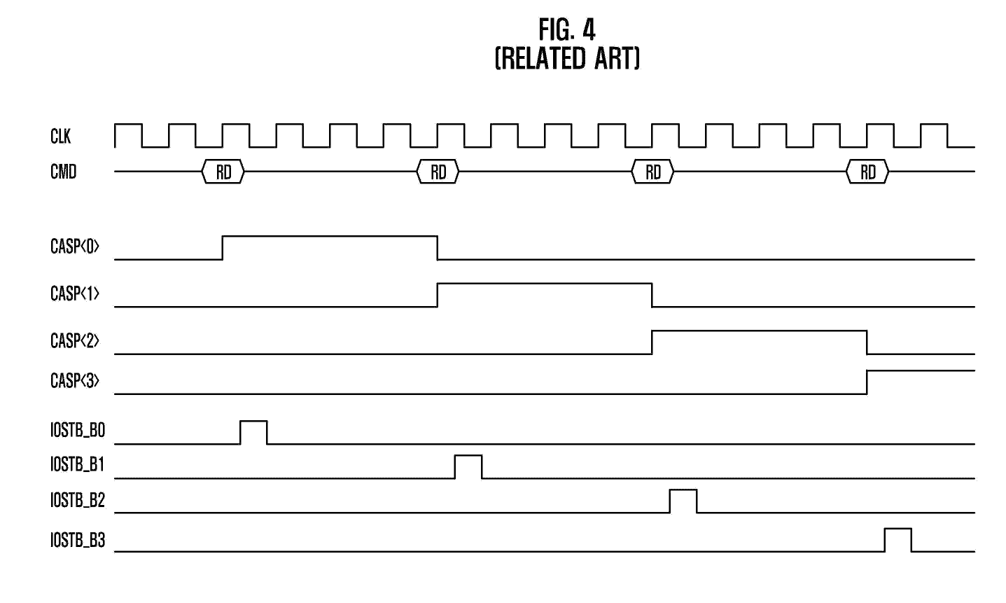

FIG. 5 is a timing diagram illustrating a read operation of a typical semiconductor memory device in a parallel test mode.

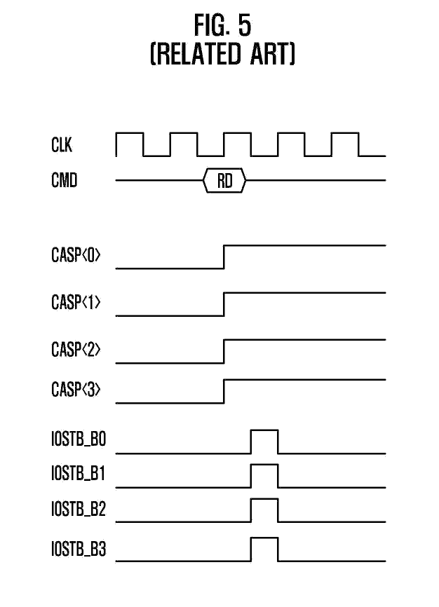

FIG. 6 is a block diagram of a semiconductor memory device in accordance with an embodiment of the present invention.

FIG. 7 is a timing diagram illustrating an operation of the semiconductor memory device of FIG. 6.

FIG. 8 is a block diagram of a semiconductor memory device in accordance with another embodiment of the invention, for operations of a normal mode and of a parallel test mode.

FIG. 9 is a circuit diagram of a control signal generator (870) shown in FIG. 8.

FIG. 10 is a timing diagram illustrating an operation of the semiconductor memory device of FIG. 8 in a parallel test mode.

### DESCRIPTION OF SPECIFIC EMBODIMENTS

Hereinafter, a semiconductor memory device in accordance with the present invention will be described in detail with reference to the accompanying drawings.

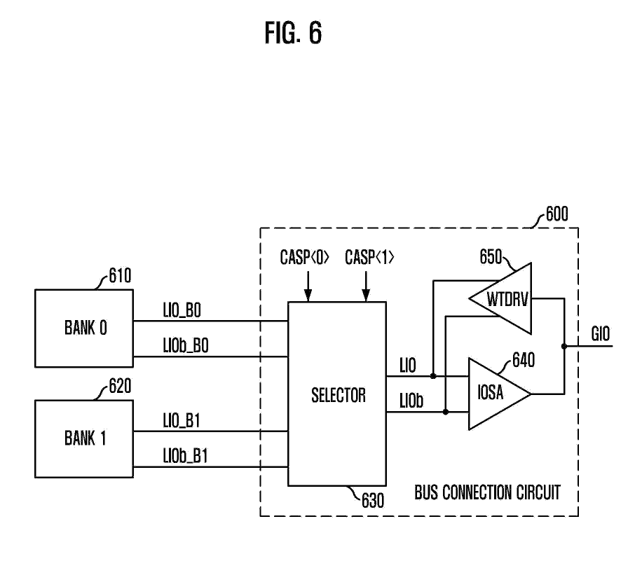

FIG. 6 is a block diagram of a semiconductor memory device in accordance with an embodiment of the invention. The semiconductor memory device has at least two multiple memory banks including memory banks 610 and 620 and a bus connection circuit 600. The memory banks 610 and 620 are each provided with a plurality of local data bus pairs. The bus connection circuit 600 is commonly connected to the local data bus pairs corresponding to the two or more memory banks to perform a selective data transfer between a global data bus and the local data bus pairs.

The bus connection circuit 600 includes a selector 630, an input/output sense amplifier 640 and a write driver 650. The selector 630 is configured to connect one of a local data bus pair LIO_B0/LIOB_B0 of the bank 610 and a local data bus pair LIO_B1/LIOB_B1 of the bank 620 that is selected according to a bank address, to the input/output sense amplifier 640 and the write driver 650. For example, when the bank 0 610 is selected according to the bank address, the local data bus pair LIO_B0/LIOB_B0 is connected to a line pair LIO/LIOB. When the bank 1 620 is selected according to the bank address, the local data bus pair LIO_B1/LIOB_B1 is connected to a line pair LIO/LIOB.

The selector 630 receives a column command signal CASP<0> of the bank 0 610 and a column command signal CASP<1> of the bank 1 620. The column command signals CASP<0> and CASP<1> are activated only when a column command (read/write) is input and the corresponding bank is selected according to the bank address. Accordingly, the selector 630 is controlled by the column command signals CASP<0> and CASP<1> to connect one of the local data bus pair LIO_B0/LIOB_B0 of the bank 0 610 and the local data bus pair LIO_B1/LIOB_B1 of the bank 1 620 that is selected according to the bank address, to the input/output sense amplifier 640 and the write driver 650.

The above-described selector 630 can be easily designed by those skilled in the art, and thus a more detailed description thereof is omitted herein.

The input/output sense amplifier 640 is configured to transfer the data output from the selector 630 to the global bus GIO. In the typical semiconductor memory device, each local data bus is provided with a input/output sense amplifier. However, in the semiconductor memory device in accordance with the embodiment, the two local data bus pairs LIO_B0/LIOB_B0 and LIO_B1 and LIOB_B1 of the two banks 610 and 620 share the single input/output sense amplifier 640. Accordingly, the number of the input/output sense amplifiers in the whole semiconductor memory device can be reduced by 50%. Although FIG. 6 shows the case where the input/output sense amplifier 640 is shared by the two local data bus pairs LIO_B0/LIOB_B0 and LIO_B1/LIOB_B1 of the two banks 610 and 620, the semiconductor may also be designed such that the single input/output sense amplifier 640 is shared by three or more banks. However, if too many banks share a single input/output sense amplifier, the distance between the banks may rather increase the size of the semiconductor memory device.

The write driver 650 is configured to transfer the data on the global bus GIO to the selector 630. Then, the data are transferred to one of the local data bus pair LIO_B0/LIOB_B0 of the bank 0 610 and the local data bus pair LIO_B1/LIOB_B1 of the bank 1 620 that is selected by the selector 630 according to the bank address. In the typical semiconductor memory device, each local data bus is provided with a write driver. However, in the semiconductor memory device in accordance with the embodiment, the two local data bus pairs LIO_B0/LIOB_B0 and LIO_B1 and LIOB_B1 of the two banks 610 and 620 share the single write driver 650. Accordingly, the number of the write drivers in the whole semiconductor memory device can be reduced by 50%. Although FIG. 6 shows the case where the write driver 650 is shared by the two banks 610 and 620, the semiconductor may also be designed such that the write driver 650 is shared by three or more banks.

As described above, the actual semiconductor memory device includes a plurality of banks (e.g., four or eight banks), and each bank is provided with a plurality of local data bus pairs (e.g., 128 local data bus pairs for an 8-bit prefetch and ×16 semiconductor memory device). However, for convenience of explanation, only a few banks, local data bus pairs, bus connection circuits and global buses are shown in the drawings of the present disclosure.

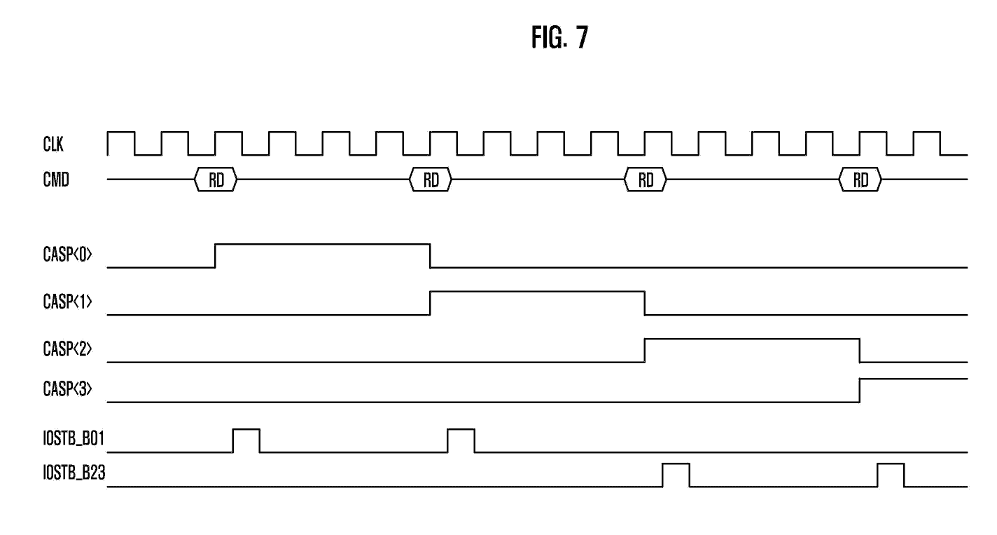

FIG. 7 is a timing diagram illustrating an operation of the semiconductor memory device of FIG. 6. FIG. 7 illustrates a case where the semiconductor memory device includes four banks, i.e., a bank 0 and a bank 1 sharing a bus connection circuit and a bank 2, and a bank 3 sharing another bus connection circuit.

When a first read command RD is input together with a bank address for selecting the bank 0 610, the column command signal CASP<0> of the bank 0 610 is activated. Then, bank 0 610 performs a read operation to transfer data to the local data bus pair LIO_B0/LIOB_B0. Because the column command signal CASP<0> of the bank 0 610 is activated, the selector 630 transfers the data on the local data bus pair LIO_B0/LIOB_B0 to the input/output sense amplifier 640. Then, the input/output sense amplifier 640 amplifies the data to load the amplified data on the global bus GIO, in response to the strobe signal IOSTB_B01.

Because bank 0 610 and bank 1 620 share the input/output sense amplifier 640, the semiconductor memory device is designed such that the strobe signal IOSTB_B01 is activated while the bank 0 610 performs the read operation and also activated while the bank 1 620 performs the read operation. The generation of the above described strobe signal IOSTB_B01 can be easily realized by those skilled in the art, and thus a more detailed description thereof is omitted herein.

As a second read command RD is input together with a bank address for selecting bank 1 620, the column command signal CASP<1> of the bank 1 620 is activated. Then, bank 1 620 performs a read operation to transfer data to the local data bus pair LIO_B1/LIOB_B1. Because the column command signal CASP<1> of the bank 1 620 is activated, the selector 630 transfers the data on the local data bus pair LIO_B1/LIOB_B1 to the input/output sense amplifier 640. Then, the input/output sense amplifier 640 amplifies the data to load the amplified data on the global bus GIO, in response to the strobe signal IOSTB_B01.

Read operations of bank 2 and bank 3, which are performed in response to a third read command RD and a fourth read command RD, respectively, are identical to the above-described read operations of the bank 0 and the bank 1, but with respect to CASP<2> and CASP<3> and IOSTB_B23.

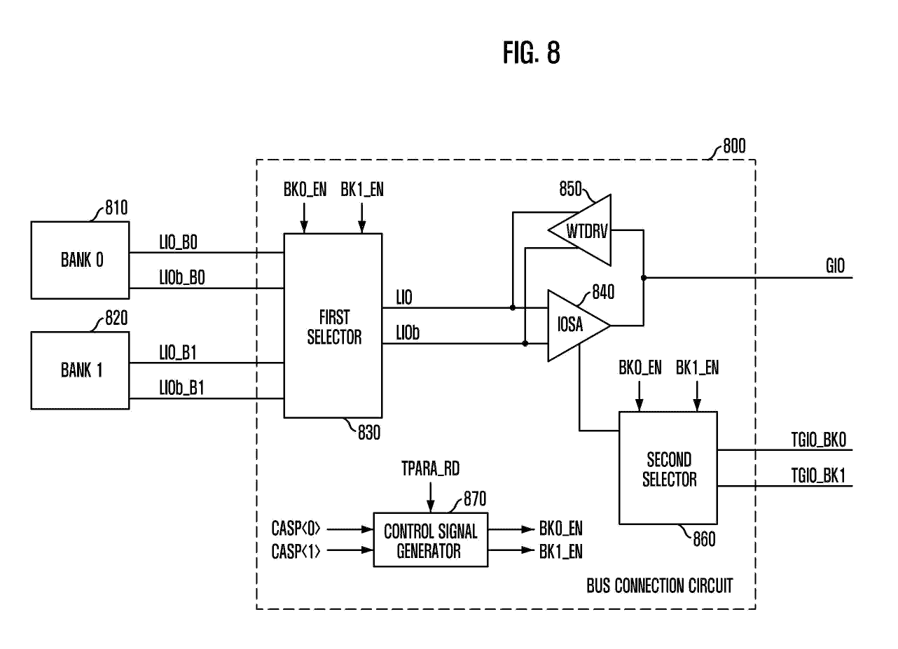

FIG. 8 is a block diagram of a semiconductor memory device in accordance with another embodiment of the present invention, for operations of a normal mode and of a parallel test mode. Contrary to FIG. 6, which illustrates a semiconductor memory device for operations of a normal mode, FIG. 8 illustrates a semiconductor memory device for operations of both a normal mode and a parallel test mode.

The semiconductor memory device of FIG. 8 includes a plurality of memory banks 810 and 820, and a bus connection circuit 800. The memory banks 810 and 820 are provided with local data bus pairs LIO_B0/LIOB_B0 and LIO_B1/LIOB_B1, respectively. The bus connection circuit 800 is commonly connected to two or more local data bus pairs LIO_B0/LIOB_B0 and LIO_B1/LIOB_B1 corresponding to two or more memory banks 810 and 820. The bus connection circuit 800 performs a selective data transfer between the local data bus pairs LIO_B0/LIOB_B0 and LIO_B1/LIOB_B1 and a global data bus GIO. Meanwhile, during a read operation of a parallel test mode, the bus connection circuit 800 performs a selective data transfer between the local data bus pairs LIO_B0/LIOB_B0 and LIO_B1/LIOB_B1 corresponding to the two or more memory banks 610 and 610, and test buses TGIO_BK0 and TGIO_BK1 corresponding to the two or more memory banks.

The control signal generator 870 generates control signals BK0_EN and BK1_EN of a first selector 830. Column command signals CASP<0> and CASP<1> input to the control signal generator 870 are the same signals as the signals described above with reference to FIG. 6. A parallel test read signal TPARA_RD is a signal activated during a write operation of the parallel test mode.

When the parallel test read signal TPARA_RD is deactivated, i.e., during the operations of the normal mode and during the write operation of the parallel test mode, the column command signals CASP<0> and CASP<1> and the control signals BK0_EN and BK1_EN are generated such that the column command signals CASP<0> and CASP<1> are identical to the control signals BK0_EN and BK1_EN, respectively (i.e., CASP<0>=BK0_EN and CASP<1>=BK1_EN). Therefore, during the operations of the normal mode, when the bank 0 810 is selected, the control signal BK0_EN is activated, and when the bank 1 820 is selected, the control signal BK1_EN is activated. During the write operation of the parallel test mode, the control signals BK0_EN and BK1_EN are simultaneously activated because all the column command signals CASP<0> and CASP<1> are activated regardless of the bank address in the parallel test mode.

When the parallel test read signal TPARA_RD is activated, i.e., during the read operation of the parallel test mode, the control signals BK0_EN and BK1_EN are sequentially activated. After the activation of the control signal BK0_EN, the control signal BK1_EN is activated. A more detailed description of the control signal generator 870 will be described below with reference to the accompanying drawings.

Operations of the first selector 830 are identical to those of the selector 630 in FIG. 6, except the control signals thereof. When the control signal BK0_EN is activated, the local data bus pair LIO_B0/LIOB_B0 of the bank 0 810 is connected to the input/output sense amplifier 840 and the write driver 850. When the control signal BK1_EN is activated, the local data bus pair LIO_B1/LIOB_B1 of the bank 1 820 is connected to the input/output sense amplifier 840 and the write driver 850. As described above, during the write operation of the parallel test mode, the control signals BK0_EN and BK1_EN are simultaneously activated, and the local data bus pairs LIO_B0/LIOB_B0 and LIO_B1/LIOB_B1 of the bank 0 810 and the bank 1 820 are all connected to the write driver 850. During the read operation of the parallel test mode, the control signals BK0_EN and BK1_EN are sequentially activated, and thus the local data bus pair LIO_B0/LIOB_B0 of the bank 0 810 is connected to the input/output sense amplifier 840, and thereafter, the local data bus pair LIO_B1/LIOB_B1 of the bank 1 820 is connected to the input/output sense amplifier 840.

The write driver 850 transfers the data on the global bus GIO to the first selector 830. Accordingly, during the write operation of the normal mode, the data are transferred to one of the local data bus pair LIO_B0/LIOB_B0 of the bank 0 810 and the local data bus pair LIO_B1/LIOB_B1 of the bank 1 820 that is selected according to the bank address. During the write operation of the parallel test mode, as described above, the local data bus pair LIO_B0/LIOB_B0 of the bank 0 810 and the local data bus pair LIO_B1/LIOB_B1 of the bank 1 820 are simultaneously connected to the write driver 850. Resultantly, the data on the global bus GIO are simultaneously transferred to the local data bus pair LIO_B0/LIOB_B0 of the bank 0 810 and the local data bus pair LIO_B1/LIOB_B1 of the bank 1 820. This is because the parallel test is performed to examine, after writing the same data on all the cells, whether the data are exactly written on the cells, and thus it is preferable simultaneously to write the same data on the bank 0 810 and the bank 1 820.

During the read operation of the normal mode, the input/output sense amplifier 840 transfers the data received from the first selector 830 to the global bus GIO. However, during the read operation of the parallel test mode, the input/output sense amplifier 840 transfers the data received from the first selector to a second selector 860.

When the control signal BK0_EN is activated, the second selector 860 transfers the data output from the input/output sense amplifier 840 to the test bus GIO_BK0. However, when the control signal BK1_EN is activated, the second selector 860 transfers the data output from the input/output sense amplifier 840 to the test bus GIO_BK1. As described above, during the read operation of the parallel test mode, the control signals BK0_EN and BK1_EN are activated alternately. Hence, the output data of the input/output sense amplifier 840 are first transferred to the test bus TGIO_BK0, and then transferred to the test bus TGIO_BK1. As a result, the data output from the bank 0 810 are transferred to the test bus TGIO_BK0, and the data output from the bank 1 820 are transferred to the test bus TGIO_BK1.

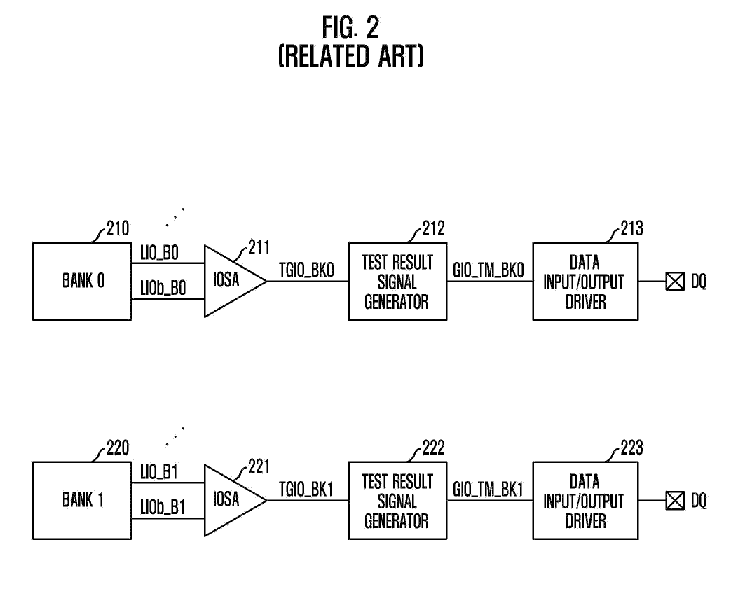

Hereinafter, the overall operation of the semiconductor memory device of FIG. 8 in the parallel test mode will be described briefly. During the write operation of the parallel test mode, the data on the global bus GIO are simultaneously transferred to both the local data bus pair LIO_B0/LIOB_B0 of the bank 0 810 and the local data bus pair LIO_B1/LIOB_B1 of the bank 1 820. Hence, the same data are written on the bank 0 810 and the bank 1 820 at the same time. During the read operation of the parallel test mode, the data on the local data bus pair LIO_B0/LIOB_B0 of the bank 0 810 are transferred to the test bus TGIO_BK0 by the write driver 850. Then, the data on the local data bus pair LIO_B1/LIOB_B1 of the bank 1 820 are transferred to the test bus TGIO_BK1 by the write driver 850. The data transferred to the test bus TGIO_BK0 and the data transferred to the test bus TGIO_BK1 are compressed with other data of the bank 0 810 and the bank 1 820, respectively, which has been described above with reference to FIG. 2. Contrary to the typical semiconductor memory device inputting all data at the same time to the test result signal generator, the semiconductor memory device in accordance with the embodiment inputs the data sequentially to the test result signal generator. That is, the time for transferring the data on the test bus TGIO_BK0 and the time for transferring the data on the test bus TGIO_BK1 are slightly different. However, because such a timing difference easily can be realized by a simple design modification, a detailed description thereof is omitted herein.

During the read operation of the parallel test mode, all the banks 810 and 820 output the data at the same time, and the data of the bank 810 and the data of the bank 820 are compressed separately. Accordingly, the number of the test buses TGIO_BK0 and TGIO_BK1 in the semiconductor memory device is identical to the number of the local data bus pairs LIO_B0/LIOB_B0 and LIO_B1/LIOB_B1. However, the number of the input/output sense amplifiers 840 is smaller than the number of the local data bus pairs LIO_B0/LIOB_B0 and LIO_B1/LIOB_B1. Therefore, in the semiconductor memory device in accordance with the embodiment, the data are transferred sequentially.

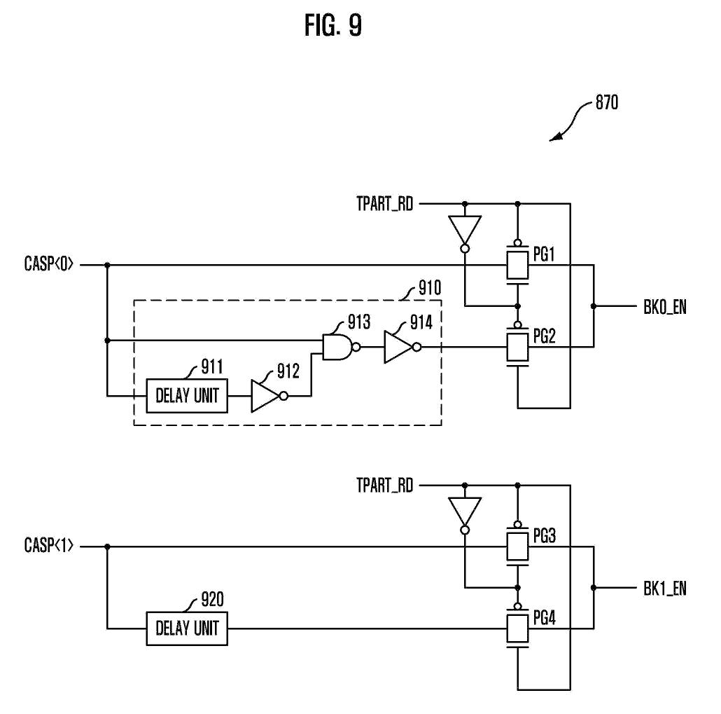

FIG. 9 is a circuit diagram of the control signal generator 870 in FIG. 8.

The control signal generator 870 includes pass gate units PG1, PG2, PG3 and PG4, a pulse generation unit 910, and a delay unit 920. The pass gate units PG1, PG2, PG3 and PG4 are turned on/off according to whether a read operation of the parallel test mode is being performed or not.

When the parallel test read signal TPARA_RD is deactivated, i.e., when the read operation of the parallel test mode is not being performed, the pass gate units PG1 and PG3 are turned on. Then, the column command signals CASP<0> and CASP<1> are directly output as control signals BK0_EN and BK1_EN (i.e., CASP<0>=BK0_EN and CASP<1>=BK1_EN).

When the parallel test read signal TPARA_RD is activated, i.e., during the read operation of the parallel test mode, the pass gate unit PG2 is turned on. Then, the column command signal CASP<0> passed through the pulse generation unit 910 is output as the control signal BK0_EN. As a result, the control signal BK0_EN is a pulse signal activated for a predetermined time after the activation of the column command signal CASP<0>. In addition, when the parallel test read signal TPARA_RD is activated, the pass gate unit PG4 is turned on. Then, the column command signal CASP<1> passed through the delay unit 920 is output as the control signal BK1_EN. As a result, the control signal BK1_EN is activated after a predetermined time from the activation of the column command signal CASP<1>.

In the parallel test mode, the column commands CASP<0> and CASP<1> are activated at the same time, and thus the control signal BK0_EN is first activated, and then the control signal BK1_EN is activated.

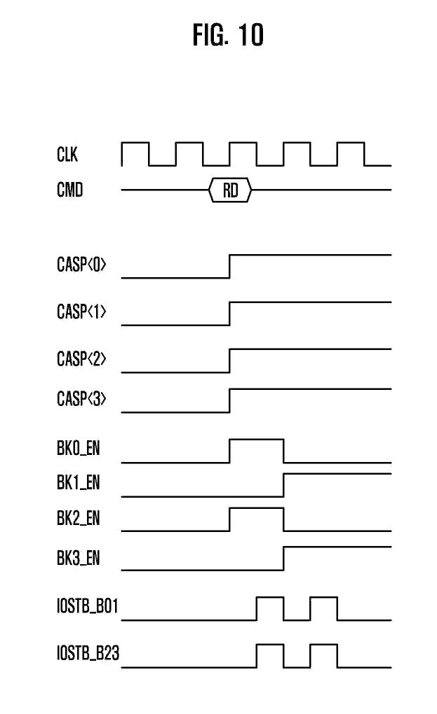

FIG. 10 is a timing diagram illustrating the operation of the semiconductor memory device of FIG. 8 in the parallel test mode. FIG. 10 illustrates a case where the semiconductor memory device includes four banks, i.e., a bank 0 and a bank 1 sharing a bus connection circuit, and a bank 2 and a bank 3 sharing another bus connection circuit.

When a read command RD is input in the parallel test mode, all the column command signals CASP<0:3> of respective banks are activated regardless of the bank address. Then, the control signals BK0_EN and BK2_EN are activated, and thereafter, the control signals BK1_EN and BK3_EN are activated alternately. As a result, the data of the bank 0 and the bank 2 are transferred to the data bus while the control signals BK0_EN and BK2_EN are activated, and the data of the bank 1 and the bank 3 are transferred to the data bus while the control signals BK1_EN and BK3_EN are activated.

Referring to FIG. 10, in the parallel test mode, the strobe signals IOSTB_B01 and IOSTB_B23 for enabling the input/output sense amplifier (IOSA) are activated twice for each read command RD, respectively. This is because a single input/output sense amplifier (IOSA) is shared by the two banks, and thus the input/output sense amplifier (IOSA) needs to operate twice for each read command RD. The activation of the strobe signals IOSTB_B01 and IOSTB_B23 to satisfy the above-described condition can be realized easily by those skilled in the art, and thus a detailed description thereof is omitted herein.

According to the embodiments of the invention, the input/output sense amplifier (IOSA) and the write driver (WTDRV) are shared by two or more banks. As such, the number of the input/output sense amplifiers (IOSA) and the write drivers (WTDRV) can be reduced by at least 50%. This may result in significant reduction of the net die size of the semiconductor memory device.

Reduction of the net die size may also reduce the manufacturing cost of the semiconductor memory device and thus improve the competitive power of the semiconductor memory device manufacturer.

While the invention has been described with respect to specific embodiments, it will be apparent to those skilled in the art that various changes and modifications may be made without departing from the spirit and scope of the invention as defined in the following claims.

Particularly, the bus connection circuit is described to be shared by two banks. However, it is also possible to design the semiconductor memory device such that the bus connection circuit is shared by three or more banks.

What is claimed is:

1. A semiconductor memory device, comprising:
a plurality of memory banks;
a plurality of local data buses associated with the plurality of memory banks; and
a bus connection circuit connected to the local data buses associated with two or more of the plurality of memory banks to perform a selective data transfer between a global data bus and the local data buses associated with the two or more of the plurality of memory banks.

2. The semiconductor memory device as recited in claim 1, wherein the bus connection circuit is configured to perform a data transfer between the global data bus and a corresponding one of the local data buses that is associated with a one of the memory bank selected according to a bank address.

3. A semiconductor memory device, comprising:
a plurality of memory banks;
a plurality of local data buses associated with the plurality of memory banks;
a selector connected to corresponding ones of the local data buses that are associated with two or more of the plurality of memory banks, to select data loaded on one of the local data buses associated with the two or more of the plurality of memory banks; and
a sense amplifier configured to transfer the data selected by the selector to a global data bus.

4. The semiconductor memory device as recited in claim 3, wherein the selector is configured to select the data loaded on the local data bus that is associated with the memory bank selected according to a bank address.

5. A semiconductor memory device, comprising:
a plurality of memory banks;
a plurality of local data buses associated with the plurality of memory banks;
a write driver configured to transfer data loaded on a global data bus to the local data buses associated with the plurality of memory banks; and
a selector connected to the local data buses that are associated with two or more of the plurality of memory banks, to select one of the local data buses on which the data transferred from the write driver is loaded.

6. The semiconductor memory device as recited in claim 5, wherein the selector is configured to select the local data bus that is associated with the memory bank selected according to a bank address.

7. A semiconductor memory device, comprising:
a plurality of memory banks provided with a plurality of local data buses; and
a bus connection circuit connected to the local data buses that are associated with the two or more memory banks to perform a selective data transfer between a global data bus and the local data buses,
wherein the bus connection circuit is configured to perform a selective data transfer between the local data buses that are associated with the two or more memory banks and test buses corresponding to the two or more memory banks during a read operation of a parallel test mode.

8. A semiconductor memory device, comprising:
a plurality of memory banks;
a plurality of local data buses associated with the plurality of memory banks;
a first selector connected to the local data buses that are associated with two or more of the plurality of memory banks to select data loaded on one of the local data buses according to a bank address in a normal mode, and sequentially to select data loaded on the local data buses associated with the two or more of the plurality of memory banks, during a read operation of a parallel test mode;
a second selector; and
a sense amplifier, receiving the data loaded on one of the local data buses from the first selector and configured to transfer the received data to a global data bus in a normal mode, and to transfer the received data to the second selector in the parallel test mode,
wherein the second selector is configured sequentially to transfer the data received from the sense amplifier to two or more test buses.

9. The semiconductor memory device as recited in claim 8, further comprising a write driver configured to transfer the data on the global bus to the first selector, wherein the first selector is configured to select all the local data buses connected thereto during a write operation of the parallel test mode.
